(19) United States
(12) Patent Application Publication
(10) Pub. No.: US 2026/0277396 A1
(43) Pub. Date: Sep. 17, 2026

(54) SIGNAL QUERY METHOD AND APPARATUS APPLIED TO UGC EDITOR, AND DEVICE

(71) Applicant: Tencent Technology (Shenzhen) Company Limited, Shenzhen (CN)

(72) Inventors: Jiahui LI, Shenzhen (CN); Guiquan ZHANG, Shenzhen (CN); Jinmiao XU, Shenzhen (CN); Xin CHEN, Shenzhen (CN); Yiming WEI, Shenzhen (CN)

(21) Appl. No.: 19/667,444

(22) Filed: May 4, 2026

Related U.S. Application Data
(63) Continuation of application No. PCT/CN2025/082207, filed on Mar. 12, 2025.

(30) Foreign Application Priority Data
Apr. 24, 2024 (CN) 202410496763.3

(51) Int. Cl. G06F 3/0482; A63F 13/63; A63F 13/77; G06F 3/0484; G06F 16/248; G06T 19/00; A63F 13/52; G06F 3/04817

(52) U.S. Cl. CPC G06F 3/0482; A63F 13/63; A63F 13/77; G06F 3/0484; G06F 16/248; G06T 19/00; A63F 13/52; G06F 3/04817; G06T 2200/24

(57) ABSTRACT

A signal query method applied to a user-generated content (UGC) editor is performed by a terminal. The method includes: displaying an entry control of a signal presentation interface in a UGC editor; displaying the signal presentation interface in response to a trigger operation for the entry control; and, in response to a selection operation for a first signal of the at least one signal, displaying a details presentation interface of the first signal for presenting details information of the first signal. According to the method, the related information of a signal in a UGC virtual environment is clearly presented to a user, thereby reducing difficulty in searching for a signal in the UGC virtual environment, allowing the user to conveniently and quickly find a needed signal, and improving efficiency of creating the UGC virtual environment.

### CROSS-REFERENCE TO RELATED APPLICATIONS

This application is a continuation application of PCT Patent Application No. PCT/CN2025/082207, entitled “SIGNAL QUERY METHOD AND APPARATUS APPLIED TO UGC EDITOR, AND DEVICE” filed on Mar. 12, 2025, which claims priority to Chinese Patent Application No. 202410496763.3, entitled "SIGNAL QUERY METHOD AND APPARATUS APPLIED TO UGC EDITOR, AND DEVICE" filed on Apr. 24, 2024, all of which are incorporated herein by reference in their entirety.

### FIELD OF THE TECHNOLOGY

Embodiments of this application relate to the field of computer and Internet technologies, and to a signal query method and apparatus applied to a user-generated content (UGC) editor, and a device.

### BACKGROUND OF THE DISCLOSURE

With the development of computer technologies, games have gradually become one of main entertainment items favored by people. Nowadays, there are all kinds of games, and many games provide a function allowing creation by users in the games to improve levels of participation of the users.

In related technologies, a game features a virtual environment customization function that allows users to create their own virtual environments, such as customizing levels in the virtual environments, or customizing decorations in the virtual environments. During customization of a virtual environment, occurrence of a game event is triggered in the customized virtual environment by using a signal.

In the related technologies, when editing a signal, users need to rely on their memory and logical judgment to search for the signal, resulting in a problem of difficult signal searching.

### SUMMARY

Embodiments of this application provide a signal query method and apparatus applied to a UGC editor, and a device. The technical solutions provided in the embodiments of this application are as follows:

According to an aspect of the embodiments of this application, a signal query method applied to a UGC editor is performed by a terminal and the method including:

displaying an entry control of a signal presentation interface in the UGC editor, the UGC editor being configured to create a UGC virtual environment;

in response to a trigger operation on the entry control by a user of the terminal, displaying the signal presentation interface, the signal presentation interface including presentation content of signals in the UGC virtual environment and the signals being used for triggering corresponding events in the UGC virtual environment; and

in response to a selection operation for a first signal by the user of the terminal, generating a details presentation interface of the first signal in the signal presentation interface, the details presentation interface of the first signal being used for presenting a signal source of the first signal, the signal source being at least one of a trigger source that transmits the first signal and a receiver source that receives the first signal, and the details presentation interface of the first signal including at least one of a trigger source control corresponding to the trigger source and a receiver source control corresponding to the receiver source, respectively.

According to an aspect of the embodiments of this application, a terminal is provided, including a processor and a memory storing a computer program, the computer program being loaded and executed by the processor and causing the terminal to implement the foregoing signal query method applied to a UGC editor.

According to an aspect of the embodiments of this application, a non-transitory computer-readable storage medium is provided, storing a computer program, the computer program being loaded and executed by a processor of a terminal and causing the terminal to implement the foregoing signal query method applied to a UGC editor.

The technical solutions provided in the embodiments of this application include at least the following beneficial effects:

A novel signal query manner applied to a UGC editor is provided. A terminal displays a signal presentation interface in response to a trigger operation for an entry control of the signal presentation interface, displays, in the signal presentation interface, presentation content of at least one signal in a UGC virtual environment, and displays, in response to a selection operation for a first signal of the at least one signal, a details presentation interface of the first signal, the at least one signal being used for triggering at least one event in the UGC virtual environment. In this method, presentation content of one or more signals in the UGC virtual environment is collected and collated, so that the presentation content of the one or more signals in the UGC virtual environment is clearly presented to a user through the signal presentation interface, and details information of the selected first signal of the plurality of signals is displayed through the details presentation interface of the first signal. This helps reduce difficulty in searching for a signal in the UGC virtual environment, allowing the user to conveniently and quickly find a needed signal, thereby improving efficiency of creating the UGC virtual environment, and improving human-computer interaction efficiency.

### BRIEF DESCRIPTION OF THE DRAWINGS

FIG. 1 is a schematic diagram of a solution implementation environment according to an embodiment of this application.

FIG. 2 is a flowchart of a signal query method applied to a UGC editor according to an embodiment of this application.

FIG. 3 is a schematic diagram of a UGC virtual environment editing interface according to an embodiment of this application.

FIG. 4 is a schematic diagram of a details presentation interface of a signal according to an embodiment of this application.

FIG. 5 is a schematic diagram of a details interface of a signal source according to an embodiment of this application.

FIG. 6 is a flowchart for collecting and updating a signal set according to an embodiment of this application.

FIG. 7 is a block diagram of a signal query apparatus applied to a UGC editor according to an embodiment of this application.

FIG. 8 is a structural block diagram of a terminal according to an embodiment of this application.

### DESCRIPTION OF EMBODIMENTS

To make the objectives, technical solutions, and advantages of this application clearer, the following further describes implementations of this application in detail with reference to the accompanying drawings.

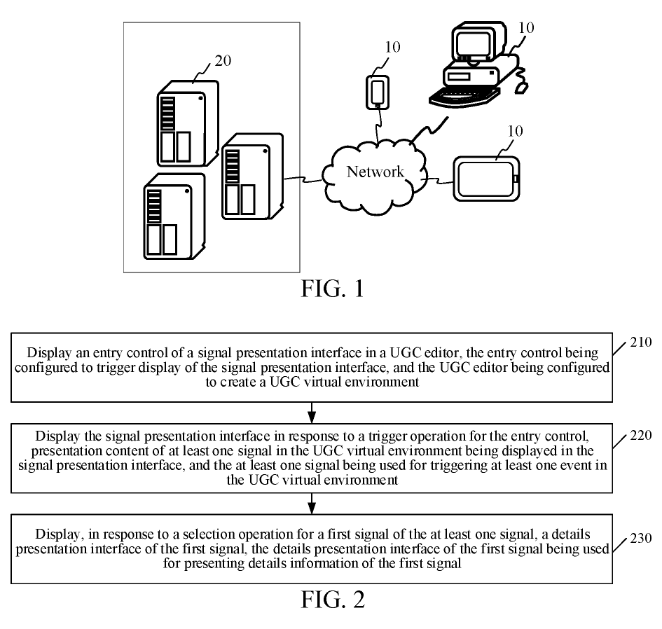

FIG. 1 is a schematic diagram of a solution implementation environment according to an embodiment of this application. The solution implementation environment may be implemented as an application program system. The application program system may include a terminal 10 and a server 20.

The terminal 10 includes, but is not limited to, an electronic device such as a mobile phone, a tablet computer, an intelligent voice interaction device, a game host, a wearable device, a multimedia playback device, a personal computer (PC), an in-vehicle terminal, an intelligent appliance, an Augmented Reality (AR) device, or a Virtual Reality (VR) device. A client of a target application (such as a game application) may run on the terminal 10. In some embodiments, the target application may be an application needing to be downloaded and installed, or may be in a form of a web page or a mini program. This is not limited in this embodiment of this application.

In this embodiment of this application, the target application may include, but is not limited to, any one of a level-clearing game application, a multiplayer online battle arena (MOBA) game application, a city construction and management simulation game application, an action adventure game application, a social application, an interactive entertainment application, and the like.

In some embodiments, the target application is a level-clearing game application. A level-clearing game is a game type in which passing a series of challenging levels is a main objective. A user needs to face various obstacles, enemies, or puzzles in the game to complete each level and finally achieve a victory condition of the game.

The server 20 is configured to provide a backend service for the client of the target application in the terminal 10. For example, the server 20 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, content delivery network (CDN), big data, and an artificial intelligence platform.

The terminal 10 and the server 20 may communicate with each other through a network. The network may be a wired network or a wireless network.

FIG. 2 is a flowchart of a signal query method applied to a UGC editor according to an embodiment of this application. Operations of the method may be performed by the terminal 10 in the solution implementation environment shown in FIG. 1. For example, the operations may be performed by the client of the target application. In the following embodiments, for ease of description, that the operations are performed by a "client" is used as an example for description. The method may include at least one operation of operation 210, operation 220, and operation 230 as follows:

Operation 210: Display an entry control of a signal presentation interface in the UGC editor, the entry control being configured to trigger display of the signal presentation interface, and the UGC editor being configured to create a UGC virtual environment.

UGC, namely, user-generated content, refers to content created and shared by a user on the Internet, and may include one or more types of the following content: text, an image, a video, audio, and the like. The UGC may be published and shared through an Internet channel such as social media, a blog forum, or a video sharing platform. In this embodiment of this application, application to the field of game UGC is used as an example. In this case, a target application provides a necessary mechanism and a corresponding UGC editing capability in a game. For example, a built-in tool, editor, or module system is provided in the target application to allow a user to create, share, and enjoy a UGC virtual environment together with other users. In some embodiments, the UGC may be one or a combination of a plurality of types of the following content: a scene, a map, a level, a character, an item, a plot, a task, or the like. Therefore, the UGC editor is an editor that is provided by the target application for the user and that is configured to make UGC. In some embodiments, the UGC editor is configured to provide a tool, a virtual element, help information, and the like for making the UGC, allowing the user to freely create a work of the user.

The virtual element refers to an element constituting the UGC virtual environment. The virtual element does not have a physical entity, and is configured to simulate at least one of an entity, a scene, and an effect of a physical world. The virtual element includes, but is not limited to, at least one of the following elements: a virtual object, a virtual entity, a virtual effect, a virtual event, a virtual camera, and a virtual interface element, or may be another element, designed by a person skilled in the art. This is not limited in this application. The virtual object may be a virtual object controlled by a user, or may be a non-player character (NPC) object created in the UGC virtual environment. The virtual entity is a virtual element that is simulated or created in the UGC virtual environment and that has a shape, an attribute, and a phase. The virtual entity may be a simulated building, obstacle, item, or the like. The virtual effect refers to a virtual element simulating various visual effects, such as a lighting effect, a particle effect, and a fume effect. The virtual event refers an event triggered by a user or triggered automatically. The virtual camera refers to a virtual element configured to simulate a visual angle of a camera, and is configured for observing a UGC virtual scene. The virtual interface element refers to an interface element in the UGC virtual environment, for example, a button, a menu, or a dialog box, or may be another interface element. This is not limited in this application.

The UGC virtual environment refers to a virtual world or virtual space constructed by UGC or constructed by using the UGC editor. A user may create and share content in the virtual space. For example, the user creates a map, a level, a character, an item, a plot, and the like in the virtual space, and the foregoing content constitutes the UGC virtual environment.

In some embodiments, the UGC virtual environment is a UGC level map, and the UGC level map is a game level designed and created by a user. For example, in a multiplayer level-clearing game, the UGC level map may be a user-designed map route that includes various obstacles, or may be a user-defined gameplay map designed and implemented by a user. In the UGC level map, a user participating in the game can successfully clear a level only after completing a designed game task. For example, in a racing game, the UGC level map may be a racing track route designed by a user.

In some embodiments, the UGC virtual environment is a UGC work exhibition, and the UGC work exhibition is used for presenting works created by a user. The works may be literature works, artistic works, music works, video works, or the like made by a user by using the UGC editor. For example, the UGC virtual environment is a UGC work exhibition for presenting literature works. A user designs, based on a created literature work by using the UGC editor, a picture, an effect, a virtual object, and the like related to content of the literature work, to present in a richer form the literature work created by the user. For example, the UGC virtual environment is a UGC exhibition for presenting artistic works. A user uses the UGC editor to design a presentation effect for a single work, or design a presentation effect for an association between a plurality of works, so that another user can better interpret the presented artistic work.

The entry control of the signal presentation interface is displayed in the UGC editor. The entry control is configured to trigger display of the signal presentation interface, and may also be referred to as a signal query entry. In some embodiments, the entry control may be an explicit control, may be implemented by using, including but not limited to, at least one of the following interactive elements: an icon, a button, and a menu, or may be implemented by using another interactive element. This is not limited in this application. For example, the entry control is a button provided in a toolbox of the UGC editor.

In some embodiments, the entry control may be an implicit control. For example, the display of the signal presentation interface is triggered by controlling a virtual object in a game. For example, the display of the signal presentation interface is triggered by an Artificial Intelligence (AI) assistant in a game. The AI assistant is configured to provide a user with services such as prompt, suggestion, and help.

The virtual object refers to an interactive element in the target application. In an example in which the target application is a game application, the virtual object is a virtual character controlled by a user or a server in the game application. For example, the virtual object is a hero selected by the user before a game match starts, and in the game match, the user controls actions of the hero in the game. The virtual object may be in a form of a human, an animal, or a cartoon character, or in other forms. This is not limited in this embodiment of this application. The virtual object may be presented in a three-dimensional form or in a two-dimensional form. This is not limited in this embodiment of this application. In some embodiments, when the virtual environment is a three-dimensional virtual environment, the virtual object is a three-dimensional model, for example, a three-dimensional model created based on an animation skeleton technology. Each virtual object has a shape and a volume in the three-dimensional virtual environment, and occupies a part of space in the three-dimensional virtual environment. Activities of the virtual object include, but are not limited to, at least one of the following: adjusting a body posture, crawling, walking, running, riding, flying, jumping, driving, picking-up, shooting, attacking, and throwing. Exemplarily, the virtual object is a virtual character, such as a simulated character or an anime character. In some implementations, the virtual object may alternatively be implemented by using a 2.5-dimensional model or 2-dimensional model. This is not limited in this embodiment of this application. The virtual object may be controlled by a server, or may be controlled by a user through a client. This is not limited in this application.

In some embodiments, the entry control of the signal presentation interface is displayed in a UGC virtual environment editing interface. The UGC virtual environment editing interface further includes an entry control of another function interface in the game, and a layout of the entry control in the UGC virtual environment editing interface is designed by a related person. This is not limited in this application.

Operation 220: Display the signal presentation interface in response to a trigger operation for the entry control, presentation content of at least one signal in the UGC virtual environment being displayed in the signal presentation interface, and the at least one signal being used for triggering at least one event in the UGC virtual environment.

The trigger operation for the entry control is an operation performed by a user for triggering the display of the signal presentation interface. The trigger operation for the entry control includes at least one of the following: clicking/tapping, double-clicking/tapping, sliding, touching and holding, triggering by voice, triggering by moving a virtual object, or triggering by transmitting a request. For example, when the entry control is an icon or a button, the user clicks/taps the entry control to display the signal presentation interface. For example, when the entry control is a menu, the entry control is clicked/tapped to pull a plurality of selection controls, and interfaces providing different services correspond to different selection controls. A selection control corresponding to the signal presentation interface is clicked/tapped to display the signal presentation interface. For example, the entry control is implemented by controlling a virtual object in the game. The virtual object is controlled to move to a designated location, and the signal presentation interface is displayed. For example, the entry control is implemented by using an AI assistant in the game. The AI assistant transmits a request for displaying the signal presentation interface, and the signal presentation interface is displayed.

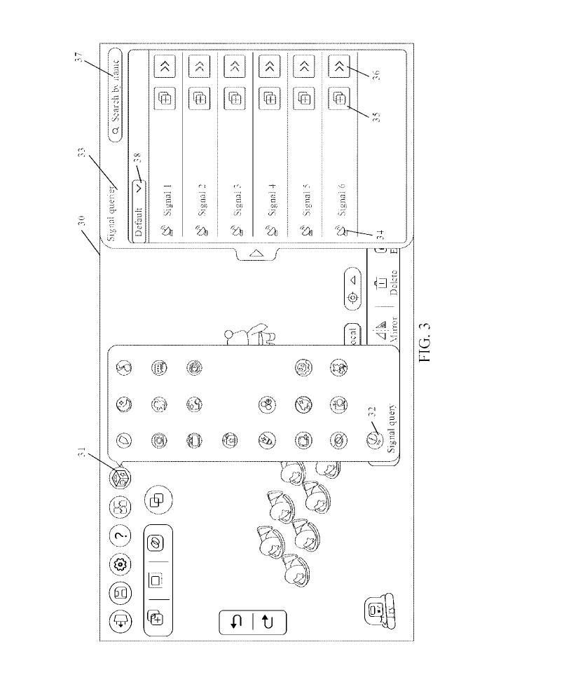

For example, the entry control is referred to as a signal query entry. FIG. 3 is a schematic diagram of a UGC virtual environment editing interface according to an embodiment of this application. A menu control 31 is displayed in a UGC virtual environment editing interface 30. The menu control 31 is clicked/tapped to pull a plurality of selection controls. A signal query entry 32 is a selection control corresponding to a signal presentation interface. The signal query entry 32 is clicked/tapped to display a signal presentation interface 33.

The signal presentation interface may be displayed in a form of a pop-up window. Presentation content of at least one signal in a UGC virtual environment is displayed in the signal presentation interface. The at least one signal may be all or some of all signals provided by the UGC editor, or may be all or some of signals currently used in the UGC virtual environment.

When the at least one signal in the UGC virtual environment is presented in the signal presentation interface, one of the following layout manners may be used: a list layout, a grid layout, a map layout, and a random layout. Alternatively, the at least one signal may be presented in another layout manner. This is not limited in this application.

When the at least one signal in the signal presentation interface is presented in a list layout, the signal presentation interface is also referred to as a signal list interface, each of the at least one signal corresponds to a list item, and each list item supports sliding up, down, left, and right. For example, in the signal presentation interface 33, the at least one signal in the UGC virtual environment is presented in a list layout, and one list item corresponds to presentation content of one signal.

The signal is a mechanism that is provided by the UGC editor to a user in the UGC virtual environment and that is used for notifying, triggering, or controlling an event or behavior in the game. The user triggers, by using a user-defined signal triggering and receiving mechanism, an animation, an interface, an effect, a dialog, and the like that have logic in the UGC virtual environment.

In some embodiments, the at least one signal corresponds to a plurality of signal types, and for each of the at least one signal, a signal type of the signal is used for indicating characteristics of the signal. In some embodiments, the signal type of the signal may be one of the following types: trigger signal, time signal, input signal, physical collision signal, state change signal, timer signal, programming signal, and the like, or may be another signal type, which is set by a related person according to a requirement. This is not limited in this application.

The signal is used for triggering an event in the UGC virtual environment, and one signal is used for triggering at least one event in the UGC virtual environment. The event triggered by the signal refers to various actions, plots, or interaction operations that occur in the UGC virtual environment. Exemplarily, a type of the event includes at least one of the following: input event, collision event, interaction event, timed event, particular condition event, and time event. The event may be manually triggered by a user or automatically triggered by the UGC virtual environment. The event is used in the UGC virtual environment to push a game process, change a game state, and provide interactivity.

User-triggered events include, but are not limited to, the following types of events: an input event, a collision event, an interaction event, and the like, or may be another user-triggered event. This is not limited in this application.

The input event refers to an event triggered by a user through an input device. For example, a virtual element in the UGC virtual environment may be dragged to a specified location.

The collision event refers to an event triggered when virtual elements in the UGC virtual environment collide with each other. For example, when a virtual object controlled by the user collides with a virtual entity, display of pop-up window content is triggered.

The interaction event refers to an event triggered when the user interacts with a virtual element in the UGC virtual environment. The interaction event may also be construed as a result generated during interaction. In some embodiments, the interaction event refers to an event triggered when the virtual object controlled by the user interacts with another virtual object in the UGC virtual environment. The interaction refers to at least one of the following: a dialog, greeting, exchanging items, picking up an item, or fighting together. The interaction event includes at least one of the following: obtaining a game prop, obtaining game currency, obtaining a game award, leveling up, increasing or decreasing attribute values, and increasing or decreasing hit points. The another virtual object may be any one of the following: a virtual item, a virtual character (such as an NPC) controlled by a system, or a virtual object controlled by another user. For example, when a virtual object controlled by a user has a dialog with an NPC object in the UGC virtual environment, an event of obtaining game currency is triggered. When virtual objects controlled by users greet each other, an event of obtaining a game prop is triggered.

The event automatically triggered by the UGC virtual environment includes, but is not limited to, the following types of events: a timed event, a particular condition event, a time event, and the like, or may be another event automatically triggered by the UGC virtual environment. This is not limited in this application.

The timed event refers to an event triggered based on a timer or a countdown timer set in the UGC virtual environment. For example, when a time recorded by the timer in the UGC virtual environment reaches a preset time, a flower blooming event is automatically triggered. For example, when countdown by the countdown timer in the UGC virtual environment ends, an event of releasing a fireworks effect is automatically triggered.

The condition event refers to an event triggered when a particular condition is satisfied in the UGC virtual environment. The condition may be preconfigured according to an actual technical requirement. The condition may be at least one of the following: completing a specified task, reaching a specified level, arriving at a specified location, picking up a specified game prop, and obtaining a specified game award. For example, when a user completes a specified task in the UGC virtual environment, an event of displaying an animation effect is automatically triggered.

The time event refers to an event triggered when a system time in the UGC virtual environment reaches a preset time. The system time may be a time of the terminal, or may be a time in the UGC virtual environment. The preset time may be a time point or a time period. For example, when the system time reaches 00:00, January 1, 2024, an event of displaying a New Year animation effect is automatically triggered.

Presentation content of a signal is used for presenting related information of the signal and a control related to the signal.

In some embodiments, for each of the at least one signal, presentation content of the signal displays at least one of a signal icon, signal identification information, a copy control, and a redirection control.
(1) The signal icon is used for graphically presenting the signal.
(2) The signal identification information is configured for indicating a name of the signal.
(3) The copy control is configured to copy the signal identification information of the signal.
(4) The redirection control is configured to trigger display of a details presentation interface of the signal.

Each signal has a corresponding signal icon. The signal icon of each of the at least one signal may be the same or may be different. For example, when the signal icon is used only for indicating that the presentation content corresponds to one signal, the signal icon of each of the at least one signal is the same. For example, when different signal icons correspond to different signal types, when a signal type of each of the at least one signal is different, the signal icon of each of the at least one signal is different. For example, in the signal presentation interface 33, the signal icon 34 merely indicates that the presentation content corresponds to one signal. Therefore, signal content of other signals also uses the same signal icon 34.

Each signal has corresponding signal identification information. The signal identification information is configured for distinguishing different signals. In this embodiment, the signal identification information may be a name of a signal. When the signal identification information is different, it indicates that names of signals are different. For example, six different signals are displayed in the signal presentation interface 33, one list item corresponds to presentation content of one signal, and names of the signals indicated by the signal identification information of the six signals are different, which are respectively "signal 1", "signal 2", "signal 3", "signal 4", "signal 5", and "signal 6". The signal identification information in the foregoing example is merely an example, and may alternatively be another specific name, such as a "flower blooming signal" or a "day change signal". This is not limited in this application.

Each signal has a corresponding copy control, and the copy control is configured to copy, after being triggered, signal identification information corresponding to the signal to a clipboard. In some embodiments, in response to a trigger operation for the copy control, the signal identification information corresponding to the signal indicated by the copy control is copied to the clipboard. The clipboard refers to a function provided by an operating system of the terminal of the user, and is used for temporarily storing data copied or clipped by the user. For example, in the signal presentation interface 33, a name of "signal 6" may be copied to the clipboard by clicking/tapping a copy control 35 of "signal 6".

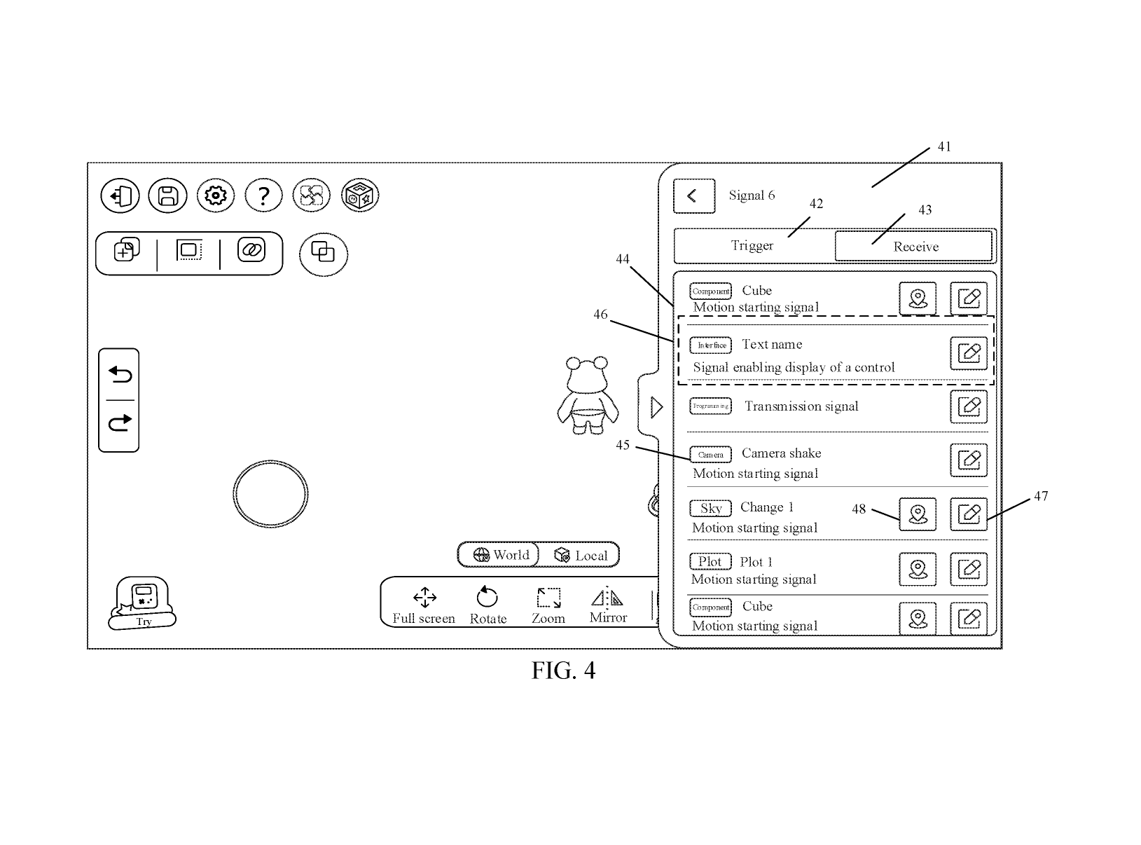

Each signal has a corresponding redirection control, and the redirection control is configured to view, after being triggered, detailed content of the signal, or redirect, after being triggered, to a details presentation interface of the signal. The details presentation interface may be displayed in a form of a pop-up window. In some embodiments, in response to a trigger operation for the redirection control, the details presentation interface of the signal indicated by the redirection control is displayed. For example, in the signal presentation interface 33, a redirection control 36 of "signal 6" is clicked/tapped to redirect to a details presentation interface 41 of "signal 6" shown in FIG. 4.

In some embodiments, each signal further has a corresponding signal copy control, the presentation content of the signal further includes the signal copy control, and the signal copy control is configured to copy the signal. For example, in response to a trigger operation for the signal copy control, a signal obtained through copying by the signal copy control is displayed on the signal presentation interface.

In the foregoing manner, related information of each signal in the UGC virtual environment is clearly presented in the signal presentation interface, and an appropriate amount of guiding information of the signal in the UGC virtual environment is provided for the user, thereby helping the user better edit the signal.

Operation 230: Display, in response to a selection operation for a first signal of the at least one signal, a details presentation interface of the first signal, the details presentation interface of the first signal being used for presenting details information of the first signal.

The first signal is a signal selected from the at least one signal in the UGC virtual environment. In some embodiments, the first signal may be one signal, or may be a group of signals of a same signal type, and a group refers to at least two. The selection operation for the first signal of the at least one signal includes at least one of the following: clicking/tapping, double-clicking/tapping, sliding, and touching and holding. For example, a redirection control of the first signal may be clicked/tapped, or a region in which the first signal is in the signal presentation interface may be double-clicked/tapped, or another manner may be used for implementation. This is not limited in this application.

The details information of the first signal refers to detailed description of specific attributes, features, and meanings of a generalized first signal. In some embodiments, the details information of the first signal may include, but is not limited to, the following content: a signal type, a signal source, a signal introduction, a signal function, and the like, or may include other content related to the first signal. This is not limited in this application.

A signal source of a signal is used for transmitting and/or receiving the signal, and a same signal source may transmit and receive a same signal. Specifically, a signal source of a signal includes at least one of the following: at least one trigger source and at least one receiver source. In some embodiments, the details presentation interface of the first signal is used for presenting the signal source of the first signal. The signal source includes at least one of a trigger source and a receiver source. The trigger source of the first signal is a virtual element that is in the UGC virtual environment and that transmits the first signal, and the receiver source of the first signal is a virtual element that is in the UGC virtual environment and that receives the first signal.

The signal source of the first signal refers to a signal source configured to transmit and/or receive the first signal. The signal source of the first signal may be presented in the details presentation interface of the first signal in one of the following layout manners: a list layout, a grid layout, a map layout, and the like. Alternatively, the signal source of the first signal may be presented in another layout manner. This is not limited in this application.

The trigger source and the receiver source of the first signal may be displayed in a same interface, or may be displayed in different interfaces. This is not limited in this application. For example, the trigger source and the receiver source of the first signal are both displayed in the same details presentation interface, or the trigger source of the first signal is displayed in a trigger source presentation interface and the receiver source of the first signal is displayed in a receiver source presentation interface.

In the foregoing manner, information about a trigger source and a receiver source of a selected signal is clearly presented to a user, thereby helping edit and sort the selected signal.

In some embodiments, an example in which the trigger source and the receiver source of the first signal are displayed in different interfaces is used. At least one of a trigger source control and a receiver source control is displayed in the details presentation interface of the first signal. A trigger source presentation interface of the first signal is displayed in response to a trigger operation for the trigger source control, trigger source content of at least one trigger source of the first signal being displayed in the trigger source presentation interface. A receiver source presentation interface of the first signal is displayed in response to a trigger operation for the receiver source control, receiver source content of at least one receiver source of the first signal being displayed in the receiver source presentation interface. In some embodiments, the trigger operation includes at least one of the following: clicking/tapping, double-clicking/tapping, touching and holding, or sliding.

The trigger source and the receiver source of the first signal source are presented in different interfaces, and the trigger source or the receiver source is presented by using the trigger source control or the receiver source control. The trigger operation for the trigger source control refers to an operation of triggering display of the trigger source presentation interface of the first signal. The trigger operation for the receiver source control refers to an operation of triggering display of the receiver source presentation interface of the first signal.

In some embodiments, the details presentation interface of the first signal includes two tabs, which are respectively the trigger source control and the receiver source control. In this case, the details presentation interface of the first signal, the trigger source presentation interface of the first signal, and the receiver source presentation interface of the first signal are interfaces corresponding to different tabs in the same interface. The trigger source presentation interface is displayed in the details presentation interface by clicking/tapping the trigger source control, and the receiver source interface is displayed in the details presentation interface by clicking/tapping the receiver source control.

Signal source content of a signal source is used for presenting related information of the signal source and a control related to the signal source.

FIG. 4 is a schematic diagram of a details presentation interface of a signal according to an embodiment of this application. In the details presentation interface 41 of "signal 6", a trigger source control 42 is clicked/tapped to display a trigger source presentation interface (not shown in FIG. 4), and a receiver source control 43 is clicked/tapped to display a receiver source presentation interface 44.

In the foregoing manner, a receiver source and a trigger source related to a selected signal are clearly listed for a user, thereby helping the user collate and edit the receiver source and the trigger source of the selected signal.

In some embodiments, the signal source content of the signal source includes at least one of the following: type information, signal source identification information, introduction information, an editing control, and a positioning control.
(1) The type information is configured for indicating a type of the signal source.
(2) The signal source identification information is configured for indicating a name of the signal source.
(3) The introduction information is configured for indicating a function of the first signal in the signal source.
(4) The editing control is configured to trigger display of a details interface of the signal source.
(5) The positioning control is configured to present a location of the signal source in the UGC virtual environment.

The type information is configured for indicating a type of a virtual element to which the signal source belongs. The virtual element includes, but is not limited to, at least one of the following elements: a virtual object, a virtual entity, a virtual effect, a virtual event, a virtual camera, and a virtual interface element, or may be another element, designed by a person skilled in the art. This is not limited in this application. The type information may be presented in one or more of the following forms: text, an icon, a button, and the like, or in another presentation form. This is not limited in this application. For example, in the receiver source presentation interface 44, type information 45 is presented in a form of an icon and text, and type information 45 of each receiver source is presented by displaying a name of a type of the receiver source on a rectangular icon.

The signal source identification information is configured for distinguishing different signal sources. The signal source identification information may be at least one of a name, an icon, and a graphic element of a signal source. In some embodiments, signal source identification information of different signal sources may be the same or may be different. This is not limited in this application. For example, in the receiver source presentation interface 44, for different receiver sources, the same signal source identification information may be used.

The introduction information of the signal source is configured for describing a function and an impact of the first signal on the signal source in the UGC virtual environment, for example, a way the signal source generates the signal, a signal source introduction, a signal function, or an event triggered by receiving the signal by the signal source. For example, the signal source introduction may be: a motion starting signal, a signal enabling display of a control, a transmission signal, or a motion ending signal. For example, a signal source introduction to a receiver source 46 in the receiver source presentation interface 44 is "Signal enabling display of a control". In other words, after the receiver source 46 receives the signal 6, an interface corresponding to the receiver source 46 is presented.

The details interface of the signal source provides a user with a function of editing a related attribute of the signal source. Each signal source includes at least one of an editing control and a positioning control. The editing control is configured to trigger display of the details interface of the signal source. The editing control and the positioning control may be presented in at least one of the following forms: an icon, a button, a pull-down menu, and the like. This is not limited in this application. For example, an editing control 47 and a positioning control 48 are displayed in the receiver source presentation interface 41. The editing control 47 and the positioning control 48 are both implemented by using graphical icons.

In the foregoing manner, a trigger source presentation interface or a receiver source presentation interface is displayed through a trigger source control or a receiver source control, and an appropriate amount of related information of a signal source in a UGC virtual environment is provided for the user, allowing the user to better edit a signal, thereby helping improve efficiency of creating the UGC virtual environment by the user.

In some embodiments, the details interface of the signal source is displayed in response to a trigger operation for the editing control. The details interface of the signal source is used for presenting editable attribute information of the signal source.

The trigger operation for the editing control refers to an operation of triggering display of the details interface of the signal source. The trigger operation includes at least one of the following: clicking/tapping, double-clicking/tapping, touching and holding, or sliding. For example, the editing control is clicked/tapped to display the details interface corresponding to the signal source. The user is allowed to configure and edit the signal source in the details interface of the signal source.

The editable attribute information of the signal source may include, but is not limited to, the following attributes: a basic attribute, an appearance attribute, a motion attribute, and the like, or may include another attribute. This is not limited in this application. The basic attribute may include, but is not limited to, attribute information such as collision information, a blocking type, self-projection, a restart signal, display information, a hide signal, and under action of an external force.

In some embodiments, attribute information of different signal sources may be different.

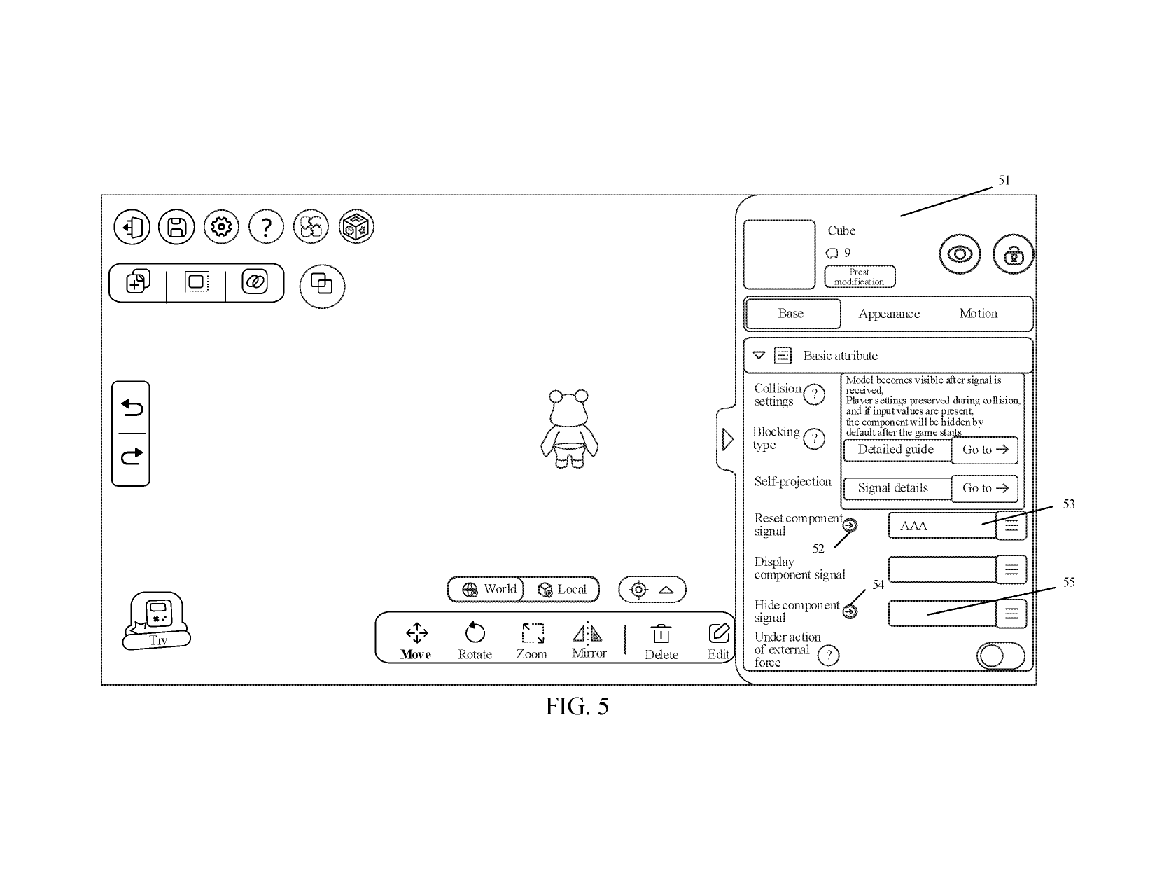

FIG. 5 is a schematic diagram of a details interface of a signal source according to an embodiment of this application. Controls for editing basic attributes such as collision information, a blocking type, self-projection, a restart signal, display information, a hide signal, and under action of an external force are displayed in a details interface 51 of a cube.

In the foregoing manner, a signal source of a specified signal is configured and edited, so that a more convenient manner is provided for a user to edit the signal and the signal source corresponding to the signal, thereby helping improve efficiency of creating a UGC virtual environment by the user.

In some embodiments, at least one of a signal quick control and a signal input box is displayed in the details interface of the signal source. The signal presentation interface is displayed in response to a trigger operation for the signal quick control when no input content is displayed in the signal input box, the input content being used for indicating a second signal of the at least one signal. A details presentation interface of the second signal is displayed when the input content is displayed in the signal input box. The signal quick control is a quick entry for signal query at the signal source, and is configured to quickly redirect to a details presentation interface of a signal. The signal quick control may also be referred to as a signal query quick entry. The trigger operation includes at least one of the following: clicking/tapping, double-clicking/tapping, touching and holding, or sliding. The input content may be at least one of a name of the second signal, a name of a signal source of the second signal, trigger source content, and receiver source content.

In other words, if a signal-related attribute in a details interface of a signal source is not configured, when an operation is performed on a signal quick control of the signal attribute, a signal presentation interface including all or some signals is displayed. If a signal-related attribute in a details interface of a signal source is configured, when an operation is performed on a signal quick control of the signal attribute, a details presentation interface of a configured signal is displayed.

For example, in the details interface 51 of the cube, if a signal quick control 52 is clicked/tapped, because input content "AAA" is displayed in a signal input box 53, a details presentation interface (not shown in FIG. 5) corresponding to the signal "AAA" is displayed. If a signal quick control 54 is clicked/tapped, because no input content is displayed in a signal input box 55, the signal presentation interface 33 shown in FIG. 3 is displayed.

In the foregoing manner, quick switching between a details presentation interface of a signal and a details interface of a signal source is implemented, thereby helping a user more easily and quickly edit the signal and the signal source.

In some embodiments, the signal source is displayed in a UGC virtual environment editing interface in response to a trigger operation for the positioning control, the UGC virtual environment editing interface being used for presenting the UGC virtual environment in an editable state. The positioning control is configured to present a location of the signal source in the UGC virtual environment and is specifically configured to focus the virtual camera on the signal source.

In some embodiments, the virtual camera is focused on a first signal source in response to a trigger operation for a positioning control of the first signal source. The virtual camera is configured to simulate a visual angle of a real camera in the UGC virtual environment.

In the foregoing manner, when the UGC virtual environment is edited, a location of a signal source that needs to be adjusted is quickly positioned, thereby helping improve efficiency of creating the UGC virtual environment by the user.

In some embodiments, a signal preview control is displayed in the UGC editor. The signal preview control is configured to trigger display of preview identification information of the at least one signal in the UGC virtual environment editing interface. The UGC virtual environment editing interface is used for presenting the UGC virtual environment in the editable state. Preview identification information of each of the at least one signal is configured for indicating a function of the signal on a trigger source of the signal and a receiver source of the signal. The preview identification information of the at least one signal is displayed in the UGC virtual environment editing interface in response to a trigger operation for the signal preview control.

The preview identification information may be presented in at least one of the following manners: an arrow, a highlighted mark, a transparent region, an icon, a symbol, a text prompt, a color mark, and the like, or may be presented in another manner. This is not limited in this application.

For example, for a trigger source and a receiver source of a same signal, an arrow of a same color is used to point from the trigger source to the receiver source, and a text prompt indicating that the signal is included in introduction information of the corresponding trigger source and receiver source is displayed on the arrow.

In the foregoing manner, preview identification information of a signal in a trigger source and a receiver source is directly displayed in the UGC virtual environment editing interface, so that a relationship between the signal and a signal source can be presented to the user more clearly.

In some embodiments, region identification information of a signal region selected from the UGC virtual environment is displayed in the UGC virtual environment editing interface in response to a signal region selection operation for the UGC virtual environment, the region identification information being configured for indicating the signal region. Preview identification information of a signal in the signal region is displayed in the UGC virtual environment editing interface in response to the trigger operation for the signal preview control.

The signal region selection operation for the UGC virtual environment refers to selecting, from the UGC virtual environment, a signal region for which preview identification information needs to be displayed. The signal region refers to a region corresponding to a signal source of a signal in the UGC virtual environment.

In some embodiments, the signal region selection operation for the UGC virtual environment may be an operation of selecting a fifth signal from at least one signal in the UGC virtual environment. Region identification information of a signal region of the fifth signal is displayed based on the fifth signal. The signal region includes regions respectively corresponding to a trigger source and a receiver source of the fifth signal.

In some embodiments, the signal region selection operation for the UGC virtual environment may alternatively be an operation of drawing a signal region in the UGC virtual environment. Region identification information of the signal region is displayed based on the drawn signal region. The signal region may be in a shape of a rectangle, a polygon, an irregular shape, or the like.

In the foregoing manner, a signal that needs to be displayed and a signal source of the signal are selected, so that only part of preview identification information is presented, thereby reducing pressure of rendering the preview identification information by the terminal.

In conclusion, according to the technical solutions provided in this application, a terminal displays a signal presentation interface in response to a trigger operation for an entry control of the signal presentation interface, displays, in the signal presentation interface, presentation content of at least one signal in a UGC virtual environment, and displays, in response to a selection operation for a first signal of the at least one signal, a details presentation interface of the first signal, the at least one signal being used for triggering at least one event in the UGC virtual environment. In this method, presentation content of a plurality of signals in the UGC virtual environment is clearly presented to a user through the signal presentation interface, and details information of the selected first signal of the plurality of signals is displayed through the details presentation interface of the first signal. This helps reduce difficulty in searching for a signal in the UGC virtual environment, allowing the user to find a needed signal conveniently and quickly, thereby improving efficiency of creating the UGC virtual environment, and improving human-computer interaction efficiency.

The signal presentation interface described above may further provide functions such as signal search, signal sorting, and signal addition. An implementation process of the functions in the signal presentation interface is described below.

In some embodiments, a search input box is further displayed in the signal presentation interface. Search information is displayed in the search input box in response to an input operation; and presentation content of at least one target signal related to the search information is displayed in the signal presentation interface.

The input operation includes at least one of the following: manual input, voice input, and speech-to-text conversion. The search input box is used for receiving search information entered by a user, and transferring the search information to the target application for a search operation. The search information refers to a key word or a phrase related to the target signal. In some embodiments, the search information includes at least one of the following information: signal identification information, a signal type, a signal source, and the like, or may further include other signal-related information, and related search logic is designed by a person skilled in the art. This is not limited in this application.

In some embodiments, the search information inputted in the search input box includes at least one character, and when the search input box receives at least one character, presentation content of at least one target signal related to the search information is displayed in the signal presentation interface. In some embodiments, when the search input box receives no character, presentation content of all or some signals in the UGC virtual environment is displayed in the signal presentation interface; or presentation content of a signal in the UGC virtual environment is not displayed in the signal presentation interface.

For example, a search input box 37 is displayed in the signal presentation interface 33. If "2" is inputted in the search input box 37, because only signal identification information of "signal 2" includes the character "2" among "signal 1", "signal 2", "signal 3", "signal 4", "signal 5", and "signal 6", presentation content (not shown in FIG. 3) corresponding to "signal 2" is displayed in the signal presentation interface 33.

Based on the foregoing example, if "signal" is inputted in the search input box 37, because signal identification information of each of "signal 1", "signal 2", "signal 3", "signal 4", "signal 5", and "signal 6" includes the six letters "signal", presentation content (not shown in FIG. 3) of each of "signal 1", "signal 2", "signal 3", "signal 4", "signal 5", and "signal 6" is displayed in the signal presentation interface.

In the foregoing manner, a user can quickly find information about a target signal from a plurality of signals by using a search input box, thereby helping improve efficiency of editing a signal in the UGC virtual environment by the user.

In some embodiments, a sorting control is further displayed in the signal presentation interface. A selection control of at least one sorting manner is displayed in response to a trigger operation for the sorting control; and in response to a trigger operation for a selection control of a first sorting manner of the at least one sorting manner, presentation content of the least one signal sorted in the first sorting manner is displayed in the signal presentation interface.

The sorting control is configured to sort presentation content of at least one signal in the signal presentation interface. In some embodiments, the sorting control may be presented in one of the following forms: a button or a pull-down menu, or may be presented in another form, set by a person skilled in the art. This is not limited in this application.

The sorting manner refers to a specific rule or standard for sorting the presentation content of the at least one signal in the signal presentation interface, to determine a sorting sequence of the at least one signal. The sorting manner may be at least one of the following manners: default sorting, name sorting, and creation time sorting, or may be another sorting manner. This is not limited in this application. The default sorting is a preset sorting manner, and a specific rule and standard for the default sorting are designed by a person skilled in the art. This is not limited in this application. The name sorting refers to performing sorting based on signal identification information of signals. For example, sorting is performed in ascending order or descending order of pinyin initials of the signal identification information of the signals based on an alphabetical sequence from A to Z.

The trigger operation for the sorting control refers to an operation of sorting manner switching. The trigger operation for the selection control of the first sorting manner of the at least one sorting manner refers to an operation of selecting the first sorting manner from the at least one sorting manner. The trigger operations for the sorting control and the selection control separately include at least one of the following: clicking/tapping, double-clicking/tapping, touching and holding, or sliding. The first sorting manner is a selected sorting manner. For example, the sorting control is clicked/tapped to switch the selection control corresponding to the first sorting manner. In this case, the sorting control and the selection control are the same control, and the presentation content of the at least one signal sorted in the first sorting manner is displayed. For example, the sorting control is clicked/tapped to pull selection controls corresponding to a plurality of sorting manners, a selection control corresponding to a first sorting manner is clicked/tapped, and presentation content of at least one signal sorted in the first sorting manner is displayed.

For example, in the signal presentation interface 33, a sorting control 38 is clicked/tapped to pull selection controls (not shown in FIG. 3) corresponding to three sorting manners. The three sorting manners are respectively default sorting, name sorting, and creation time sorting.

In the foregoing manner, a sorting function is provided for the user, allowing the user to quickly search for and manage a signal, thereby helping the user manage the signal in the UGC virtual environment.

In some embodiments, a signal addition control is further displayed in the signal presentation interface. A signal addition interface is displayed in response to a trigger operation for the signal addition control, the signal addition interface being used for adding a fourth signal to the UGC virtual environment. At least one of a to-be-added-signal input box, a trigger source selection control, a receiver source selection control, and an addition confirmation control is displayed in the signal addition interface. The trigger source selection control is configured to select a trigger source of the fourth signal, and the receiver source selection control is configured to select a receiver source of the fourth signal. It is determined to add the fourth signal to the UGC virtual environment in response to a trigger operation for the addition confirmation control when to-be-added-signal input information is displayed in the to-be-added-signal input box.

The signal addition control is configured to trigger display of the signal addition interface. In some embodiments, the signal addition interface may be presented in a form of a pop-up window. The trigger operation for the signal addition control may be at least one of the following: clicking/tapping, double-clicking/tapping, touching and holding, or sliding.

The fourth signal is a signal to be added to the UGC virtual environment. The to-be-added-signal input box is configured to receive name information of the fourth signal. The trigger source selection control is configured to select one or more signal sources from a plurality of signal sources to transmit the fourth signal. The receiver source selection control is configured to select one or more signal sources from a plurality of signal sources to receive the fourth signal. The signal source refers to a source of a signal or a virtual element that receives a signal.

In some embodiments, the signal source includes at least one of a trigger source and a receiver source, the trigger source being configured to transmit a signal, and the receiver source being configured to receive a signal. The trigger source refers to a source that triggers an event, an operation, or a signal, and after a corresponding signal is generated, the signal may be broadcast in the UGC virtual environment. The receiver source is configured to receive, process, or respond to the signal broadcast by the trigger source, and perform, based on the received signal, a series of behaviors related to the signal.

The addition confirmation control is configured to add the configured fourth signal to the UGC virtual environment. In some embodiments, it is determined to add the fourth signal to the UGC virtual environment in response to the trigger operation for the addition confirmation control when to-be-added-signal input information is displayed in the to-be-added-signal input box. In some embodiments, when to-be-added-signal input information is displayed in the to-be-added-signal input box and no operation is performed on the trigger source selection control and/or the receiver source selection control, it is determined to add the fourth signal to the UGC virtual environment.

In the foregoing manner, the user can quickly configure a new signal through the signal addition interface, and add the configured signal to the UGC virtual environment, thereby helping improve efficiency of creating the UGC virtual environment by the user.

The following describes a process of obtaining a signal set in the UGC virtual environment.

In some embodiments, map data of the UGC virtual environment is obtained, the map data being used for loading the UGC virtual environment. At least one candidate signal source in the UGC virtual environment is determined based on the map data. A signal set in the UGC virtual environment is determined based on the map data and the at least one candidate signal source, the signal set including signal content of the at least one signal, and signal content of each of the at least one signal including at least one of the following: the signal and a trigger source and a receiver source that correspond to the signal.

The map data of the UGC virtual environment refers to data of geographical or scene information in the virtual environment, and includes, but is not limited to, geographical information, scene object information, virtual entity attribute information, dynamic data information, and the like, or may include other information. This is not limited in this application. The geographical information is configured for describing geographical features of the virtual environment, and includes, but is not limited to, information such as coordinate information, terrain height information, and a terrain type of the UGC virtual environment. The scene object information is configured for describing a virtual entity in the UGC virtual environment, and includes, but is not limited to, information such as a location, a shape, a size, and a pattern of a virtual entity such as a building, a road, vegetation, a water body, and an obstacle in the UGC virtual environment. The virtual entity attribute information is configured for describing attributes of a virtual element in the UGC virtual environment, and includes, but is not limited to, information such as a material, a color, transparency, and a texture of the virtual element. The dynamic data information is configured for describing a dynamic scene and an interaction behavior in the UGC virtual environment, and includes, but is not limited to, dynamic data such as a moving track and a state change of a virtual element in the UGC virtual environment.

The map data of the UGC virtual environment may be obtained and generated in various manners, including but not limited to map data collection, three-dimensional modeling, a map editor, and other tools and technologies. The map data may be stored in various formats, including but not limited to the following formats: a map file, a scene file, a database, and the like. When there is a requirement for presenting the UGC virtual environment, the UGC virtual environment is loaded based on the map data.

The candidate signal source refers to a virtual element that may be a signal source in the UGC virtual environment. In some embodiments, the map data of the UGC virtual environment is parsed to determine at least one candidate signal source in the UGC virtual environment. A signal-related candidate signal source is matched based on signal-related information in the map data to obtain the signal set.

In some embodiments, the obtained set is stored into a map file corresponding to the map data.

In some embodiments, the signal set in the UGC virtual environment is determined based on the map data of the UGC virtual environment. For example, when the UGC virtual environment is opened for the first time, the map data of the UGC virtual environment is parsed to obtain a signal set corresponding to the UGC virtual environment, and the obtained signal set is stored in a serialization manner into a map file corresponding to the UGC virtual environment.

In some embodiments, in the signal presentation interface, signal content of at least one signal in the UGC virtual environment is displayed based on signal content of at least one signal included in the signal set.

In the foregoing manner, the map data of the UGC virtual environment is re-integrated and parsed to obtain related information of a plurality of signals in the UGC virtual environment, thereby helping clearly present a relationship between a signal and a signal source to the user.

In some embodiments, signal content of a third signal of the at least one signal is updated when the third signal is modified. The signal content of the third signal includes at least one of the following: the third signal and a trigger source and a receiver source that correspond to the third signal.

The third signal is any one of the at least one signal in the UGC virtual environment. When the user edits the third signal, the signal content of the third signal is correspondingly modified. Editing includes performing an operation such as adding, deleting, or modifying on the third signal.

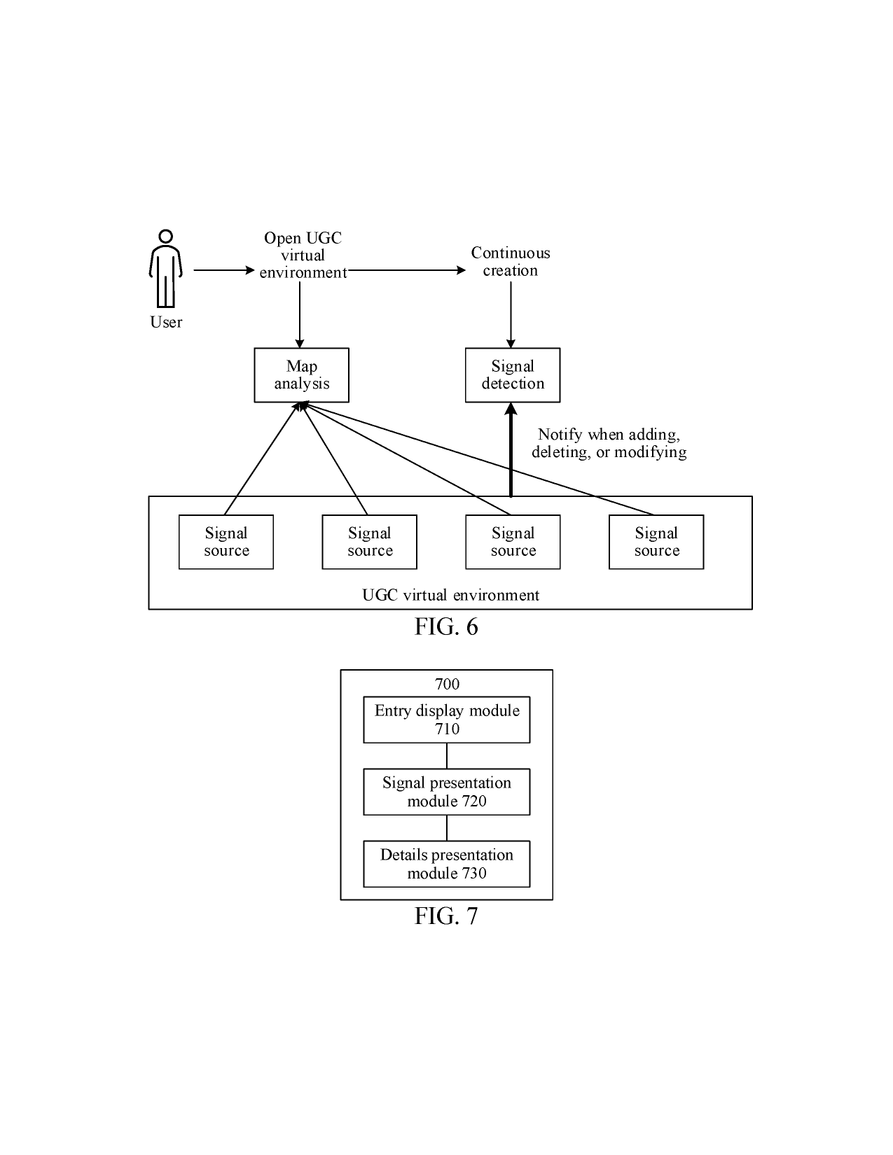

FIG. 6 is a flowchart for collecting and updating a signal set according to an embodiment of this application. When a user opens the UGC virtual environment editing interface, the map data of the UGC virtual environment is parsed to obtain the signal set of the UGC virtual environment. When the user continues to create the UGC virtual environment, when the third signal is edited, the signal content corresponding to the third signal in the signal set is modified.

In the foregoing manner, when a user modifies a signal, the related information of the modified signal is updated in time, thereby helping ensure consistency of the modified signal on a front end and a back end of a target application.

The following describes an embodiment in which a signal source serves as a main subject for presentation.

In some embodiments, a display control of a signal source presentation interface is displayed in the UGC editor, the display control being configured to trigger display of the signal source presentation interface. The signal source presentation interface is displayed in response to a trigger operation for the display control, a selection option of at least one signal source in the UGC virtual environment being displayed in the signal source presentation interface, and the at least one signal source being used for transmitting or receiving the signal. A transceiver presentation interface of the first signal source is displayed in response to a selection operation for a selection option of a first signal source of the at least one signal source, the transceiver presentation interface of the first signal source being used for presenting at least one of the following information: details information of a signal received by the first signal source and details information of a signal transmitted by the first signal source.

The signal source presentation interface is used for presenting at least one signal source in the UGC virtual environment.

In some embodiments, the selection option of the signal source displays at least one of an icon, signal source identification information, a copy control, and a redirection control.
(1) The icon is used for graphically presenting a signal source.
(2) The signal source identification information is configured for indicating a name of the signal source.
(3) The copy control is configured to copy the signal source identification information of the signal source.
(4) The redirection control is configured to trigger display of a transceiver presentation interface of the signal source.

In some embodiments, the transceiver presentation interface of the first signal source includes at least one of a signal transmitting control and a signal receiving control. The signal transmitting control is configured to trigger display of a signal transmitting presentation interface of the first signal source. The signal receiving control is configured to trigger display of a signal receiving presentation interface of the first signal source.

In some embodiments, the signal transmitting presentation interface of the first signal source is displayed in response to a trigger operation for the signal transmitting control, signal content of at least one signal transmitted by the first signal source being displayed in the signal transmitting presentation interface. The signal receiving presentation interface of the first signal source is displayed in response to a trigger operation for the signal receiving control, signal content of at least one signal received by the first signal source being displayed in the signal receiving presentation interface.

In the foregoing manner, the user is provided with a creation concept of editing with a signal source as a main subject, and the user can select, as needed, a proper manner to edit the UGC virtual environment.

As an example, the signal query method applied to a UGC editor provided in the embodiments of this application is described. In the following embodiment, the entry control is referred to as a signal query entry, the signal presentation interface is referred to as a signal list interface, the details presentation interface of the first signal is referred to as a signal details interface, and the signal quick control at the signal source is referred to as a signal query quick entry.

(1) Signal query entry

When the UGC editor is used, the signal query entry that is provided in the toolbox and that corresponds to the signal query entry 32 in FIG. 3 is used. After the signal query entry is clicked/tapped, a right-side pop-up interface for signal querying, namely, the signal list interface, which corresponds to the signal presentation interface 33 in FIG. 3, is opened.

(2) Signal list interface

A main part of the signal list interface is a signal list, and a list of all signals used in a current UGC virtual environment is displayed by default. The list supports sliding up and down. Each signal corresponds to one list item. Content of each list item includes four parts: a signal icon, used for indicating that the list item is a signal; signal identification information, used for indicating a name of a signal (not repeated); a copy button, used for copying the name of the signal to a clipboard; and a redirection button, used for redirecting to the signal details interface.

A search input box is displayed at an upper right corner of the signal list interface to support a search function. After search text is inputted for a search, only a signal including the search text is displayed on the signal list interface until the search is cleared. A sorting control is further displayed at the top of the signal list interface to support a sorting function. A sorting manner includes at least one of the following: default sorting, name sorting, and creation time sorting.

(3) Signal details interface

After a redirection button of a signal is clicked/tapped in the signal list interface, a pop-up window interface of signal details of the signal, namely, a signal details interface, corresponding to the details presentation interface 41 in FIG. 4, is entered. An interface title is "Signal name", below which are two tabs switchable to each other, namely, "Trigger" and "Receive". During tab switching, lists of signal triggering or receiver sources are switched and presented correspondingly.

Using one tab as an example, a list is displayed under each tab, and content of each list item in the list includes five parts: a label, used for indicating a type of a current signal source; a name, used for indicating a name of the current signal source; an introduction, being an introduction to a function of a current signal in the signal source; a positioning button, a signal whose type is component having a positioning button, used for focusing a scene camera on the corresponding component; and an editing button, used for quickly pulling up an editing and modification interface of the signal source.

(4) Signal query quick entry

A quick entry for signal querying, namely, the signal query quick entry, is additionally provided at the signal source, and corresponds to the signal quick control 52 in FIG. 5. A signal identifier is clicked/tapped to pull up the quick entry, and a "Go to" button is clicked/tapped to implement redirection. When no signal is filled in the signal input box, after the "Go to" button is clicked/tapped, the signal list interface described in (2) is entered. When a signal is already filled in the signal input box, for example, a signal A is already filled in, after the "Go to" button is clicked/tapped, the signal details interface described in (3) corresponding to the signal A is entered.

(5) Signal query data collection manner

The signal query data collection manner includes map analysis and signal detection. For this, refer to FIG. 6.

Map analysis refers to parsing map data when signal querying is used in the UGC editor, sifting out all signal sources of all types, and collecting a signal list and trigger source and receiver source data that correspond to a signal.

Signal detection: During continuous use of the UGC editor, behaviors of various types of signal sources are detected in a signal detection manner, and when a signal is added, deleted, or modified, related data stored in a signal query system is correspondingly modified.

(6) Implementation of signal query function

For the signal list interface, data related to a signal is placed in the interface as required for presentation, and search, sort, and copy functions are integrated. For the signal details interface, parts involving an input source and a receiver source of the signal are placed in the interface for presentation, and are integrated with icons in a classified manner. The editing button in the signal details interface can implement customization of a parameter-based redirection function for each type of signal source, and a corresponding parameter is collected during data collection.

Additionally, in the foregoing embodiments, each display interface is displayed with a signal as a main subject. Alternatively, a trigger source and a receiver source of a signal may be used as main subjects for display.

An apparatus embodiment of this application is described below, and may be configured to perform the method embodiment of this application. For details not disclosed in the apparatus embodiment of this application, reference is made to the method embodiment of this application.

FIG. 7 is a block diagram of a signal query apparatus applied to a UGC editor according to an embodiment of this application. The apparatus has a function of implementing an example of the foregoing method. The function may be implemented by hardware or may be implemented by hardware executing corresponding software. The apparatus may be the terminal 10 described above. As shown in FIG. 7, the apparatus 700 may include an entry display module 710, a signal presentation module 720, and a details presentation module 730.

The entry display module 710 is configured to display an entry control of a signal presentation interface in the UGC editor, the entry control being configured to trigger display of the signal presentation interface, and the UGC editor being configured to create a UGC virtual environment.

The signal presentation module 720 is configured to display the signal presentation interface in response to a trigger operation for the entry control, presentation content of at least one signal in the UGC virtual environment being displayed in the signal presentation interface, and the at least one signal being used for triggering at least one event in the UGC virtual environment.

The details presentation module 730 is configured to display, in response to a selection operation for a first signal of the at least one signal, a details presentation interface of the first signal, the details presentation interface of the first signal being used for presenting details information of the first signal.

In some embodiments, the details presentation interface of the first signal is used for presenting a signal source of the first signal, and the signal source includes at least one of a trigger source and a receiver source, a trigger source of the first signal being a virtual element that is in the UGC virtual environment and that transmits the first signal, and a receiver source of the first signal being a virtual element that is in the UGC virtual environment and that receives the first signal.

In some embodiments, at least one of a trigger source control and a receiver source control is displayed in the details presentation interface of the first signal. The apparatus 700 further includes a detailed presentation module (not shown in FIG. 7), configured to display a trigger source presentation interface of the first signal in response to a trigger operation for the trigger source control, trigger source content of at least one trigger source of the first signal being displayed in the trigger source presentation interface; and display a receiver source presentation interface of the first signal in response to a trigger operation for the receiver source control, receiver source content of at least one receiver source of the first signal being displayed in the receiver source presentation interface.

In some embodiments, signal source content of the signal source includes at least one of the following: type information, signal source identification information, introduction information, an editing control, and a positioning control; the type information being configured for indicating a type of the signal source; the signal source identification information being configured for indicating a name of the signal source; the introduction information being configured for indicating a function of the first signal in the signal source; the editing control being configured to trigger display of a details interface of the signal source; and the positioning control being configured to present a location of the signal source in the UGC virtual environment.

In some embodiments, the apparatus 700 further includes a signal source editing module (not shown in FIG. 7), configured to display the details interface of the signal source in response to a trigger operation for the editing control, the details interface of the signal source being used for presenting editable attribute information of the signal source; or display the signal source in a UGC virtual environment editing interface in response to a trigger operation for the positioning control, the UGC virtual environment editing interface being used for presenting the UGC virtual environment in an editable state.

In some embodiments, at least one of a signal quick control and a signal input box is displayed in the details interface of the signal source. The apparatus 700 further includes a quick presentation module (not shown in FIG. 7), configured to display, in response to a trigger operation for the signal quick control, the signal presentation interface when no input content is displayed in the signal input box, the input content being used for indicating a second signal of the at least one signal; and display a details presentation interface of the second signal when the input content is displayed in the signal input box.

In some embodiments, presentation content of each of the at least one signal displays at least one of a signal icon, signal identification information, a copy control, and a redirection control; the signal icon being used for graphically presenting the signal; the signal identification information being configured for indicating a name of the signal; the copy control being configured to copy the signal identification information of the signal; and the redirection control being configured to trigger display of a details presentation interface of the signal.

In some embodiments, a search input box is further displayed in the signal presentation interface. The apparatus 700 further includes a signal search module (not shown in FIG. 7), configured to display Search information in the search input box in response to an input operation; and display, in the signal presentation interface, presentation content of at least one target signal related to the search information.

In some embodiments, a sorting control is further displayed in the signal presentation interface. The apparatus 700 further includes a signal sorting module (not shown in FIG. 7), configured to display a selection control of at least one sorting manner in response to a trigger operation for the sorting control; and display, in the signal presentation interface in response to a trigger operation for a selection control of a first sorting manner of the at least one sorting manner, presentation content of the at least one signal sorted in the first sorting manner.

In some embodiments, the apparatus 700 further includes a signal source presentation module (not shown in FIG. 7), configured to display a display control of a signal source presentation interface in the UGC editor, the display control being configured to trigger display of the signal source presentation interface; display the signal source presentation interface in response to a trigger operation for the display control, a selection option of at least one signal source in the UGC virtual environment being displayed in the signal source presentation interface, and the at least one signal source being used for transmitting or receiving the signal; and display a transceiver presentation interface of the first signal source in response to a selection operation for a selection option of a first signal source of the at least one signal source, the transceiver presentation interface of the first signal source being used for presenting at least one of the following information: details information of a signal received by the first signal source and details information of a signal transmitted by the first signal source.

In some embodiments, the apparatus 700 further includes a signal determining module (not shown in FIG. 7), configured to obtain map data of the UGC virtual environment, the map data being used for loading the UGC virtual environment; determine at least one candidate signal source in the UGC virtual environment based on the map data; and determine a signal set in the UGC virtual environment based on the map data and the at least one candidate signal source, the signal set including signal content of the at least one signal, and signal content of each of the at least one signal including at least one of the following: the signal and a trigger source and a receiver source that correspond to the signal.

In some embodiments, the apparatus 700 further includes a signal update module (not shown in FIG. 7), configured to update signal content of a third signal of the at least one signal when the third signal is modified.

In some embodiments, a signal addition control is further displayed in the signal presentation interface. The apparatus 700 further includes a signal addition module (not shown in FIG. 7), configured to display a signal addition interface in response to a trigger operation for the signal addition control, the signal addition interface being used for adding a fourth signal to the UGC virtual environment, at least one of a to-be-added-signal input box, a trigger source selection control, a receiver source selection control, and an addition confirmation control being displayed in the signal addition interface, the trigger source selection control being configured to select a trigger source of the fourth signal, and the receiver source selection control being configured to select a receiver source of the fourth signal; and determine to add the fourth signal to the UGC virtual environment in response to a trigger operation for the addition confirmation control when to-be-added-signal input information is displayed in the to-be-added-signal input box.

In some embodiments, the apparatus 700 further includes a signal preview module (not shown in FIG. 7), configured to display, in the UGC editor, a signal preview control, the signal preview control being configured to trigger display of preview identification information of the at least one signal in the UGC virtual environment editing interface, the UGC virtual environment editing interface being used for presenting the UGC virtual environment in the editable state, and preview identification information of each of the at least one signal being configured for indicating a function of the signal on a trigger source of the signal and a receiver source of the signal; and display, in the UGC virtual environment editing interface, the preview identification information of the at least one signal in response to a trigger operation for the signal preview control.

In some embodiments, the signal preview module is further configured to display, in the UGC virtual environment editing interface in response to a signal region selection operation for the UGC virtual environment, region identification information of a signal region selected from the UGC virtual environment, the region identification information being configured for indicating the signal region; and display, in the UGC virtual environment editing interface, preview identification information of a signal in the signal region in response to the trigger operation for the signal preview control.

In conclusion, according to the technical solutions provided in this application, a terminal displays a signal presentation interface in response to a trigger operation for an entry control of the signal presentation interface, displays, in the signal presentation interface, presentation content of at least one signal in a UGC virtual environment, and displays, in response to a selection operation for a first signal of the at least one signal, a details presentation interface of the first signal, the at least one signal being used for triggering at least one event in the UGC virtual environment. In this method, presentation content of a plurality of signals in the UGC virtual environment is clearly presented to a user through the signal presentation interface, and details information of the selected first signal of the plurality of signals is displayed through the details presentation interface of the first signal. This helps reduce difficulty in searching for a signal in the UGC virtual environment, allowing the user to find a needed signal conveniently and quickly, thereby improving efficiency of creating the UGC virtual environment, and improving human-computer interaction efficiency.

When the apparatus provided in the foregoing embodiment implements the functions of the apparatus, only division of the foregoing function modules is used as an example for description. In actual application, the functions may be allocated to and completed by different function modules according to requirements. In other words, an internal structure of the device is divided into different function modules to complete all or some of the functions described above. In addition, the apparatus provided in the foregoing embodiment is based on the same concept as the method embodiment. For details of a specific implementation process of the apparatus, refer to the method embodiment. Details are not described herein again.

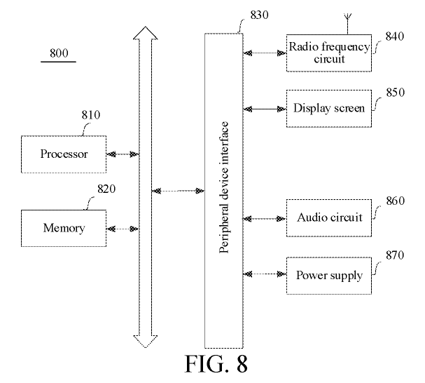

FIG. 8 is a structural block diagram of a terminal 800 according to an embodiment of this application. The terminal 800 may be the terminal 10 in the implementation environment shown in FIG. 1, and is configured to implement the signal query method applied to a UGC editor provided in the foregoing embodiment. Specifically, the terminal 800 usually includes a processor 810 and a memory 820.

The processor 810 may include one or more processing cores, for example, a 4-core processor or an 8-core processor. The processor 810 may be implemented in at least one hardware form of a digital signal processor (DSP), a field-programmable gate array (FPGA), and a programmable logic array (PLA). The processor 810 may alternatively include a main processor and a coprocessor. The main processor is configured to process data in an awake state and is also referred to as a central processing unit (CPU). The coprocessor is a low power consumption processor configured to process data in a standby state. In some embodiments, the processor 810 may be integrated with a graphics processing unit (GPU). The GPU is configured to render and draw content that needs to be displayed on a display screen. In some embodiments, the processor 810 may further include an AI processor. The AI processor is configured to process a computing operation related to machine learning.

The memory 820 may include one or more computer-readable storage media. The computer-readable storage medium may be non-transitory. The memory 820 may further include a high-speed random access memory (RAM) and a non-volatile memory, for example, one or more magnetic disk storage devices or flash storage devices. In some embodiments, the non-transitory computer-readable storage medium in the memory 820 is configured to store a computer program, and the computer program is configured to be executed by one or more processors to implement the foregoing signal query method applied to a UGC editor.

In some embodiments, the terminal 800 may, in an example, include a peripheral device interface 830 and at least one peripheral device. The processor 810, the memory 820, and the peripheral device interface 830 may be connected through a bus or a signal cable. Each peripheral device may be connected to the peripheral device interface 830 through a bus, a signal cable, or a circuit board. Specifically, the peripheral device includes at least one of a radio frequency circuit 840, a display screen 850, an audio circuit 860, and a power supply 870.

A person skilled in the art may understand that the structure shown in FIG. 8 constitutes no limitation on the terminal 800, which may include more or fewer components than those shown in the figure, or some components may be combined, or a different component deployment may be used.

In an exemplary embodiment, a computer-readable storage medium storing a computer program is further provided, the computer program, when executed by a processor, implementing the foregoing signal query method applied to a UGC editor. In some embodiments, the computer-readable storage medium may include a read-only memory (ROM), a RAM, a solid-state drive (SSD), an optical disc, or the like. The RAM may include a resistance RAM (ReRAM) and a dynamic RAM (DRAM).

In an exemplary embodiment, a computer program product including a computer program is further provided, the computer program being stored in a computer-readable storage medium. A processor of a terminal reads the computer program from the computer-readable storage medium, and executes the computer program to cause the terminal to perform the foregoing signal query method applied to the UGC editor.

Data collection and processing in this application need to be strictly in accordance with requirements of relevant laws and regulations when applied in practice, and the informed consent or separate consent of the personal information subject needs to be obtained. Subsequent data use and processing need to be carried out within the scope of authorization of laws and regulations and the personal information subject.

"A plurality of" mentioned in this specification means two or more. "And/or" describes an association relationship between associated objects and represents that three relationships may exist. For example, A and/or B may represent the following three cases: Only A exists, both A and B exist, and only B exists. The character "/" denotes an "or" relationship between the associated objects. In addition, the operation numbers described in this specification merely exemplarily show a possible execution sequence of the operations. In some other embodiments, the foregoing operations may not be performed based on the number sequence. For example, two operations with different numbers may be performed simultaneously, or two operations with different numbers may be performed based on a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A signal query method applied to a user-generated content (UGC) editor performed by a terminal, the method comprising:
displaying an entry control of a signal presentation interface in the UGC editor, the UGC editor being configured to create a UGC virtual environment;
in response to a trigger operation on the entry control by a user of the terminal, displaying the signal presentation interface, the signal presentation interface including presentation content of signals in the UGC virtual environment and the signals being used for triggering corresponding events in the UGC virtual environment; and
in response to a selection operation for a first signal by the user of the terminal, generating a details presentation interface of the first signal in the signal presentation interface, the details presentation interface of the first signal being used for presenting a signal source of the first signal, the signal source being at least one of a trigger source that transmits the first signal and a receiver source that receives the first signal, and the details presentation interface of the first signal including at least one of a trigger source control corresponding to the trigger source and a receiver source control corresponding to the receiver source, respectively.

2. The method according to claim 1, wherein the method further comprises:
displaying a trigger source presentation interface of the first signal in response to a trigger operation for the trigger source control, the trigger source presentation interface including trigger source content of at least one trigger source of the first signal; and
displaying a receiver source presentation interface of the first signal in response to a trigger operation for the receiver source control, the receiver source presentation interface including receiver source content of at least one receiver source of the first signal.

3. The method according to claim 1, wherein signal source content of the signal source comprises at least one of the following: type information, signal source identification information, introduction information, an editing control, and a positioning control;
the type information being configured for indicating a type of the signal source;
the signal source identification information being configured for indicating a name of the signal source;
the introduction information being configured for indicating a function of the first signal in the signal source;
the editing control being configured to trigger display of a details interface of the signal source; and
the positioning control being configured to present a location of the signal source in the UGC virtual environment.

4. The method according to claim 1, wherein presentation content of each of the at least one signal displays at least one of a signal icon, signal identification information, a copy control, and a redirection control;
the signal icon being used for graphically presenting the signal;
the signal identification information being configured for indicating a name of the signal;
the copy control being configured to copy the signal identification information of the signal; and
the redirection control being configured to trigger display of a details presentation interface of the signal.

5. The method according to claim 1, wherein a search input box is further displayed in the signal presentation interface; and the method further comprises:
displaying Search information in the search input box in response to an input operation by the user of the terminal; and
displaying, in the signal presentation interface, presentation content of at least one target signal related to the search information.

6. The method according to claim 1, wherein the signal presentation interface includes a sorting control and the method further comprises:
displaying a selection control of at least one sorting manner in response to a trigger operation for the sorting control by the user of the terminal; and
in response to a trigger operation for a selection control of a first sorting manner of the at least one sorting manner by the user of the terminal, displaying, in the signal presentation interface, presentation content of the at least one signal sorted in the first sorting manner.

7. The method according to claim 1, wherein the method further comprises:
displaying a display control of a signal source presentation interface in the UGC editor;
in response to a trigger operation for the display control by the user of the terminal, displaying the signal source presentation interface including a selection option of at least one signal source in the UGC virtual environment, and the at least one signal source being used for transmitting or receiving the signal; and
in response to a selection operation for a selection option of a first signal source of the at least one signal source by the user of the terminal, displaying a transceiver presentation interface of the first signal source for presenting at least one of the following information: details information of a signal received by the first signal source and details information of a signal transmitted by the first signal source.

8. The method according to claim 1, wherein the method further comprises:
obtaining map data of the UGC virtual environment;
determining at least one candidate signal source in the UGC virtual environment based on the map data; and
determining a signal set in the UGC virtual environment based on the map data and the at least one candidate signal source, the signal set comprising signal content of the at least one signal, and signal content of each of the at least one signal comprising at least one of the following: the signal and a trigger source and a receiver source that correspond to the signal.

9. The method according to claim 1, wherein the method further comprises:
displaying a signal addition interface in response to a trigger operation for a signal addition control in the signal presentation interface, the signal addition interface being used for adding a fourth signal to the UGC virtual environment, at least one of a to-be-added-signal input box, a trigger source selection control, a receiver source selection control, and an addition confirmation control being displayed in the signal addition interface, the trigger source selection control being configured to select a trigger source of the fourth signal, and the receiver source selection control being configured to select a receiver source of the fourth signal; and
determining to add the fourth signal to the UGC virtual environment in response to a trigger operation for the addition confirmation control when to-be-added-signal input information is displayed in the to-be-added-signal input box.

10. The method according to claim 1, wherein the method further comprises:
displaying, in the UGC editor, a signal preview control, the signal preview control being configured to trigger display of preview identification information of the at least one signal in the UGC virtual environment editing interface, and preview identification information of each of the at least one signal being configured for indicating a function of the signal on a trigger source of the signal and a receiver source of the signal; and
displaying, in the UGC virtual environment editing interface, the preview identification information of the at least one signal in response to a trigger operation for the signal preview control.

11. A terminal, comprising a processor and a memory storing a computer program, the computer program being loaded and executed by the processor and causing the terminal to implement a signal query method applied to a user-generated content (UGC) editor, the method including:
displaying an entry control of a signal presentation interface in the UGC editor, the UGC editor being configured to create a UGC virtual environment;
in response to a trigger operation on the entry control by a user of the terminal, displaying the signal presentation interface, the signal presentation interface including presentation content of signals in the UGC virtual environment and the signals being used for triggering corresponding events in the UGC virtual environment; and
in response to a selection operation for a first signal by the user of the terminal, generating a details presentation interface of the first signal in the signal presentation interface, the details presentation interface of the first signal being used for presenting a signal source of the first signal, the signal source being at least one of a trigger source that transmits the first signal and a receiver source that receives the first signal, and the details presentation interface of the first signal including at least one of a trigger source control corresponding to the trigger source and a receiver source control corresponding to the receiver source, respectively.

12. The terminal according to claim 11, wherein the method further comprises:
displaying a trigger source presentation interface of the first signal in response to a trigger operation for the trigger source control, the trigger source presentation interface including trigger source content of at least one trigger source of the first signal; and
displaying a receiver source presentation interface of the first signal in response to a trigger operation for the receiver source control, the receiver source presentation interface including receiver source content of at least one receiver source of the first signal.

13. The terminal according to claim 11, wherein signal source content of the signal source comprises at least one of the following: type information, signal source identification information, introduction information, an editing control, and a positioning control;
the type information being configured for indicating a type of the signal source;
the signal source identification information being configured for indicating a name of the signal source;
the introduction information being configured for indicating a function of the first signal in the signal source;
the editing control being configured to trigger display of a details interface of the signal source; and
the positioning control being configured to present a location of the signal source in the UGC virtual environment.

14. The terminal according to claim 11, wherein presentation content of each of the at least one signal displays at least one of a signal icon, signal identification information, a copy control, and a redirection control;
the signal icon being used for graphically presenting the signal;
the signal identification information being configured for indicating a name of the signal;
the copy control being configured to copy the signal identification information of the signal; and
the redirection control being configured to trigger display of a details presentation interface of the signal.

15. The terminal according to claim 11, wherein a search input box is further displayed in the signal presentation interface; and the method further comprises:
displaying search information in the search input box in response to an input operation by the user of the terminal; and
displaying, in the signal presentation interface, presentation content of at least one target signal related to the search information.

16. The terminal according to claim 11, wherein the signal presentation interface includes a sorting control and the method further comprises:
displaying a selection control of at least one sorting manner in response to a trigger operation for the sorting control by the user of the terminal; and
in response to a trigger operation for a selection control of a first sorting manner of the at least one sorting manner by the user of the terminal, displaying, in the signal presentation interface, presentation content of the at least one signal sorted in the first sorting manner.

17. The terminal according to claim 11, wherein the method further comprises:
displaying a display control of a signal source presentation interface in the UGC editor;
in response to a trigger operation for the display control by the user of the terminal, displaying the signal source presentation interface including a selection option of at least one signal source in the UGC virtual environment, and the at least one signal source being used for transmitting or receiving the signal; and
in response to a selection operation for a selection option of a first signal source of the at least one signal source by the user of the terminal, displaying a transceiver presentation interface of the first signal source for presenting at least one of the following information: details information of a signal received by the first signal source and details information of a signal transmitted by the first signal source.

18. The terminal according to claim 11, wherein the method further comprises:
obtaining map data of the UGC virtual environment;
determining at least one candidate signal source in the UGC virtual environment based on the map data; and
determining a signal set in the UGC virtual environment based on the map data and the at least one candidate signal source, the signal set comprising signal content of the at least one signal, and signal content of each of the at least one signal comprising at least one of the following: the signal and a trigger source and a receiver source that correspond to the signal.

19. The terminal according to claim 11, wherein the method further comprises:
displaying, in the UGC editor, a signal preview control, the signal preview control being configured to trigger display of preview identification information of the at least one signal in the UGC virtual environment editing interface, and preview identification information of each of the at least one signal being configured for indicating a function of the signal on a trigger source of the signal and a receiver source of the signal; and
displaying, in the UGC virtual environment editing interface, the preview identification information of the at least one signal in response to a trigger operation for the signal preview control.

20. A non-transitory computer-readable storage medium, storing a computer program, the computer program being loaded and executed by a processor of a terminal and causing the terminal to implement a signal query method applied to a user-generated content (UGC) editor, the method including:
displaying an entry control of a signal presentation interface in the UGC editor, the UGC editor being configured to create a UGC virtual environment;
in response to a trigger operation on the entry control by a user of the terminal, displaying the signal presentation interface, the signal presentation interface including presentation content of signals in the UGC virtual environment and the signals being used for triggering corresponding events in the UGC virtual environment; and
in response to a selection operation for a first signal by the user of the terminal, generating a details presentation interface of the first signal in the signal presentation interface, the details presentation interface of the first signal being used for presenting a signal source of the first signal, the signal source being at least one of a trigger source that transmits the first signal and a receiver source that receives the first signal, and the details presentation interface of the first signal including at least one of a trigger source control corresponding to the trigger source and a receiver source control corresponding to the receiver source, respectively.
